(19) United States
(12) Patent Application Publication
(10) Pub. No.: US 2025/0299096 A1
(43) Pub. Date: Sep. 25, 2025

(54) ADVANCED WIRELESS COMMUNICATION AI/ML TRAINING TECHNIQUES

(71) Applicant: Continental Automotive Technologies GmbH, Hannover (DE)

(72) Inventors: Hojin Kim, Regensburg (DE); Rikin Shah, Langen (DE); David Gonzalez Gonzalez, Egelsbach (DE); Osvaldo Gonsa, Frankfurt (DE)

(73) Assignee: Continental Automotive Technologies GmbH, Hannover (DE)

(21) Appl. No.: 18/861,621

(22) PCT Filed: Apr. 28, 2023
(86) PCT No.: PCT/EP2023/061310

§ 371 Date: Oct. 30, 2024

(30) Foreign Application Priority Data
May 5, 2022 (DE) 10 2022 204 459.2

(51) Int. Cl. G06N 20/00; H04L 41/16

(52) U.S. Cl. CPC G06N 20/00; H04L 41/16

(57) ABSTRACT

Event triggering and/or periodic approaches for artificial intelligence/machine learning (AI/ML) applications for radio access networks (RAN) are disclosed. The approaches facilitate federated learning and may include where global model located in radio access network or server base station (BS) is distributed to user equipments (UEs) after collecting local model feedback.

### CROSS-REFERENCE TO RELATED APPLICATIONS

The present application is a National Stage Application under 35 U.S.C. § 371 of International Patent Application No. PCT/EP2023/061310 filed on Apr. 28, 2023, and claims priority from German Patent Application No. 10 2022 204 459.2 filed on May 5, 2022, in the German Patent and Trademark Office, the disclosures of which are herein incorporated by reference in their entireties.

### TECHNICAL FIELD

Various embodiments generally relate to the field of wireless communications.

### BACKGROUND

Artificial intelligence (AI) or machine learning (ML) is used for many different applications and areas as it shows much higher contribution to performance improvement over the existing technologies. In wireless or mobile communication network, AI/ML can be also used for better performance in various use cases or applications when two or more devices are communicated wirelessly. However, there are also challenges to apply AI/ML and some of them include high signaling traffic load and device power consumption increase due to AI/ML operation in wireless devices.

In radio access network (RAN) with wireless devices in connection, it is necessary to consider interworking between mobile devices (UE) and base station (BS) with other network devices such as mobile edge compute device (MEC) and non-terrestrial network device (NTN), etc. so that AI/ML operation in RAN can overcome the key challenges of high signaling traffic load and device power consumption increase.

### BRIEF DESCRIPTION OF THE DRAWINGS

FIG. 1 illustrates a block diagram of an example wireless communications network environment for network devices (e.g., a UE, AN, gNB or an eNB) according to various aspects or embodiments.

FIG. 2 is a diagram showing example AI/ML federated learning in accordance with one or more embodiments.

FIG. 3 is a graph illustrating an example parameter threshold (Lₜₕ) for the event triggering method in accordance with one or more embodiments.

FIG. 4 is a flow diagram illustrating a method of distributing a threshold profile index to UE candidate set(s) in accordance with one or more embodiments.

FIG. 5 is a flow diagram illustrating a method of event triggered convergence in accordance with one or more embodiments.

FIG. 6 is a diagram illustrating signaling between a BS and UEs for an event triggered method in accordance with one or more embodiments.

FIG. 7 is a flow diagram illustrating a periodical method in accordance with one or more embodiments.

FIG. 8 is a flow diagram illustrating a hybrid method using trigger and periodical techniques in accordance with one or more embodiments.

FIGS. 9 and 10 illustrate examples of event and periodic training in accordance with one or more aspects/embodiments.

FIG. 11 is a flow diagram illustrating a hybrid method using trigger and periodical techniques in accordance with one or more embodiments.

### DETAILED DESCRIPTION

The present disclosure will now be described with reference to the attached drawing figures, wherein like reference numerals are used to refer to like elements throughout, and wherein the illustrated structures and devices are not necessarily drawn to scale. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. Embodiments herein may be related to RAN1, RAN2, 5G and the like.

As utilized herein, terms “component,” “system,” “interface,” and the like are intended to refer to a computer-related entity, hardware, software (e.g., in execution), and/or firmware. For example, a component can be a processor, a process running on a processor, a controller, an object, an executable, a program, a storage device, and/or a computer with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

Mobile communication has evolved from early voice systems to highly sophisticated integrated communication systems or platforms. Next generation wireless/mobile communication systems, such as 5G and new radio (NR) are expected to be a unified network/system that targets to meet different and even conflicting performance dimensions and services. Such diverse multi-dimensional requirements are driven by different services and applications. Generally, NR will evolve based on 3GPP LTE-Advanced with additional potential new radio access. Further, NR is expected to evolve with additional potential new radio access technologies (RATs) to enrich mobile communication with improved, simple and seamless wireless connectivity solutions. NR can enable mobile communication that provides fast and rich contents and services.

Some approaches for mobile communication utilize a model having data and an algorithmic scheme as inputs to generate an output for use cases.

An AI/ML approach uses an AI/ML model having data and training sets/data as inputs to generate an output for use cases.

It is appreciated that AI/ML and/or AI/ML models can be used for use cases, dataset collection, dataset validation, interworking and data information flow, architecture interface, processing capabilities of end devices and the like.

Artificial intelligence/machine learning (AI/ML) based techniques are can be used with 3GPP. AI/ML can be used for 5G evolution and 6G phases.

AI/ML can be used for RAN applications, such as PHY, MAC, etc. by considering BS-UE/UE-UE/BS-BS collaboration scenarios to support AI/ML operations. AI/ML can facilitate interworking and data information flow in collaboration level for AI/ML support communication modes for AI/ML support.

It is appreciated that AI/ML can enhance performances of many different layers/levels of wireless network by adopting AI/ML.

Generally, AI/ML federated learning involves a global model (g) from a BS or server distributed to a plurality of UEs after collecting local model (w) update feedback.

One or more embodiments are disclosed that facilitate managing UE participation in AI/ML model training. These include an event-triggering method, a periodical method, a combination of event triggering and periodical, and the like.

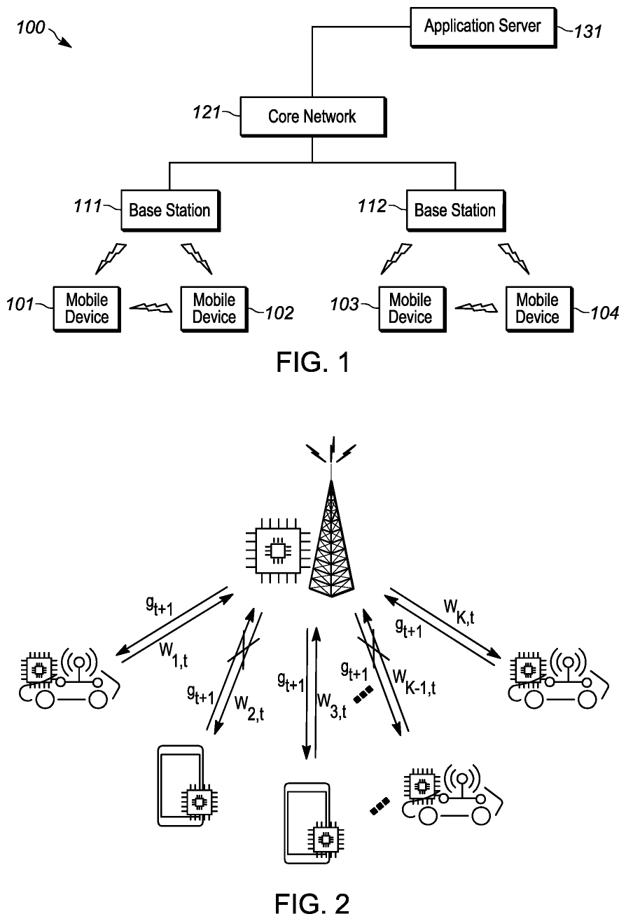

FIG. 1 illustrates an architecture of a system 100 of a network in accordance with some embodiments. The system 100 is shown to include a user equipment (UE) 101,102, 103, and 104. The UEs 101˜104 are illustrated as smartphones (e.g., handheld touchscreen mobile computing devices connectable to one or more cellular networks), but can also comprise any mobile or non-mobile computing device, such as Personal Data Assistants (PDAs), pagers, laptop computers, desktop computers, wireless handsets, automotive devices (e.g., vehicles) or any computing device including a wireless communications interface.

In some embodiments, any of the UEs 101˜104 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data can be a machine-initiated exchange of data. An IoT network describes interconnecting IoT UEs, which can include uniquely identifiable embedded computing devices (within the Internet infrastructure), with short-lived connections. The IoT UEs can execute background applications (e.g., keep-alive messages, status updates, etc.) to facilitate the connections of the IoT network.

The UEs 101˜104 can be configured to connect, e.g., communicatively couple, with a radio access network (RAN) 111 and 112—the RAN 111 and 112 can be, for example, an Evolved Universal Mobile Telecommunications System (UMTS) Terrestrial Radio Access Network (E-UTRAN), a NextGen RAN (NG RAN), or some other type of RAN. The UEs 101˜104 connect to BSs wirelessly and the air interface technologies can be based on cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 101˜104 can further directly exchange communication data via sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). A network device as referred to herein can include any one of these APs, ANs, UEs or any other network component.

In this embodiment, the CN 121 provides the functions that communicate with the UE, store its subscription and credentials, allow access to external networks & services, provide security and manage the network access and mobility.

The ANs can include circuitry (e.g., baseband circuitry), a memory, a network interface (e.g., RF interface), one or more processors and the like.

FIG. 2 is a diagram showing example AI/ML federated learning in accordance with one or more embodiments.

For AI/ML federated learning, global model (“g”) update in BS is distributed to each UEs after collecting local model (“w”) update feedback from them after initial sharing of global model configuration. However, location of global model can be not only BS, but also edge computing device or remote server etc.

This need to be done iteratively and each UE can be controlled to participate in model training more efficiently.

Supporting AI/ML operation adoption is not typically considered for current BS-UE/UE-UE/BS-BS communication.

For example, the distributed AI/ML training between BS and multiple UEs have the potential challenges such as heavy signaling traffic for training process and an increase of device power consumption.

An event-triggering method is applied to schedule the UE subset with their local AI/ML model training for global AI/ML model training in a communication mode.

To determine a UE subset, a threshold value (Lₜₕ) is set to filter out UEs not joining AI/ML model training. In particular,
UE devices to join global model training if ≥Lₜₕ (the pre-defined threshold)
UE devices NOT to join global model training if <Lₜₕ (the pre-defined threshold)

The Pre-configured threshold (Lₜₕ) can be set based on the configured threshold profile index.

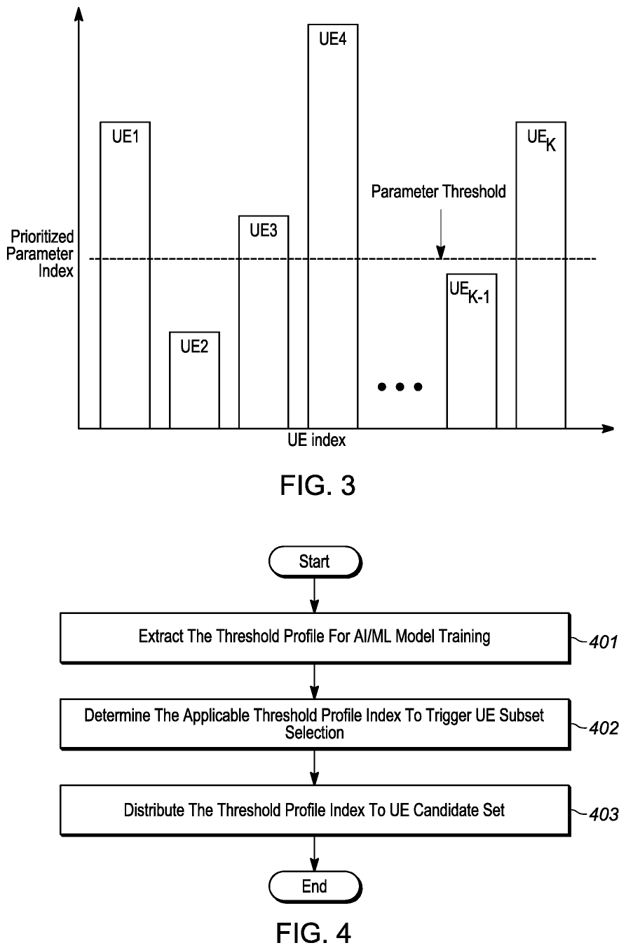

FIG. 3 is a graph illustrating an example parameter threshold (Lₜₕ) for the event triggering method in accordance with one or more embodiments.

An x-axis depicts UE index and a y-axis depicts prioritized parameter index.

The parameter threshold is shown as a dashed line.

In this example, UE devices greater than or equal to the threshold join the global model training and the UE devices below the threshold do not join.

The UE subset selection uses multi-parameter thresholds with parameter prioritization. The selection criteria is based on the pre-defined parameter thresholds for the prioritized parameters. Multiple thresholds can used for UE subset selection triggering where different weights can be assigned for each parameter prioritization for selection decision.

FIG. 4 is a flow diagram illustrating a method of distributing a threshold profile index to UE candidate set(s) in accordance with one or more embodiments. The method is shown in an order for illustrative purposes, however it is appreciated that it can operate in other suitable orders.

The method can be performed by an AN, such as a BS.

The method begins at 401, where a threshold profile for AI/ML model training is extracted.

An applicable threshold profile to trigger UE subset selection is determined at 402.

The determined threshold profile is distributed to a UE candidate set at 403.

The parameter profile of threshold index is generated based on a suitable given policy in network to apply the relevant threshold for different cases.

The parameter profile of threshold index is used to trigger UE subset to perform AI/ML local training

The parameter profile contains the parameter set of:
Communication domain: indication of link quality for wireless channel
Training domain: indication of AI/ML training configuration such as minimum number of iterations, minimum level of performance improvements, accuracy, sensitivity, data size, convergence error level
Device domain: indication of computation power, energy consumption, memory capacity
Data domain: indication of data/feature characteristics for AI/ML training

A relevant threshold index is chosen based on AI/ML model training policy with application use case.

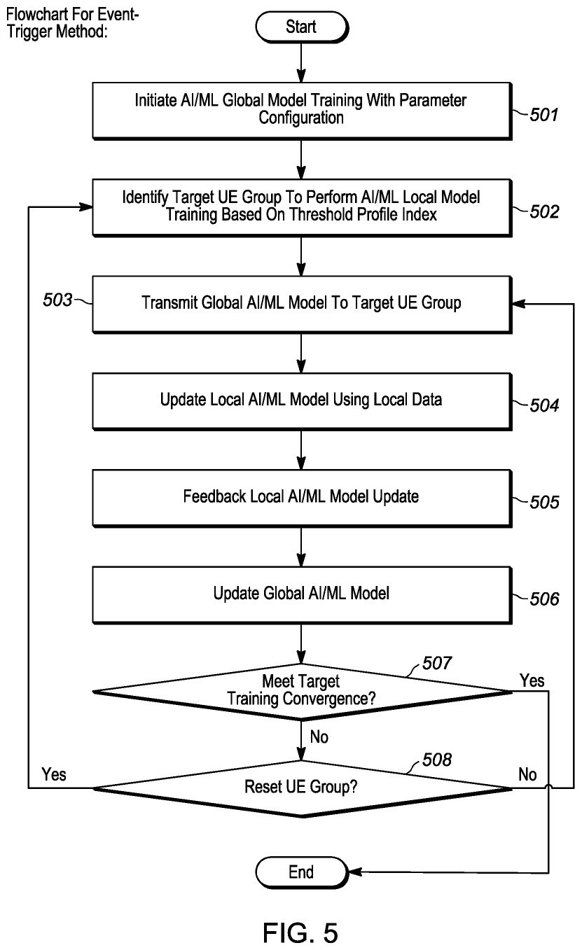

FIG. 5 is a flow diagram illustrating a method of event triggered convergence in accordance with one or more embodiments.

A BS initiates AI/ML global model training with parameter configuration at 501.

The BS identifies a target UE group to perform AI/ML local model training based on a threshold profile index at 502.

The BS transmits global AI/ML model to target UE group at 503.

The local AI/ML model is updated using local data at 504.

Feedback local AI/ML model update is generated at 505.

The BS updates the global AI/ML model at 506.

The BS determines whether the global AI/ML model meets a target training convergence at 507. If yes, the target training convergence has been obtained. If no, resetting the UE group is considered at 508 and the method returns to 502.

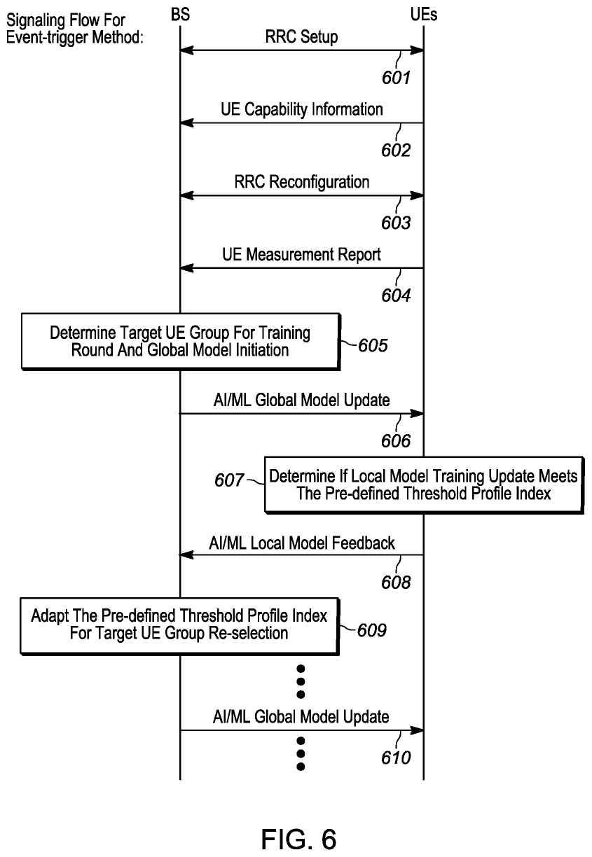

FIG. 6 is a diagram illustrating signaling between a BS and UEs for an event triggered method in accordance with one or more embodiments.

The BS and UEs signal RRC setup at 601.

The UEs provide UE capability information to the BS at 602.

The BS and UEs signal RRC reconfiguration 603.

The UEs provide UE measurement report 604.

The BS determines a target UE group for training and global model initiation at 605.

The BS provides an AI/ML global model update to the UEs at 606.

The UEs determine if a local model training update meets a pre-defined threshold profile index at 607.

The determination is provided by the UEs as AI/ML local model feedback to the BS at 608.

The BS adapts the pre-defined threshold profile index for the target UE group and (reselection) at 609.

The BS provides the AI/ML Global model update to the UEs at 610.

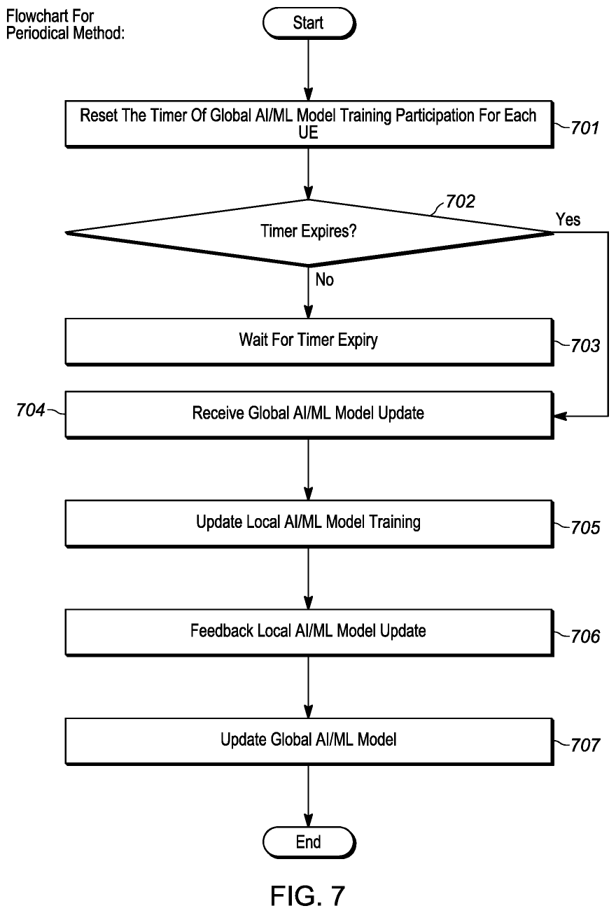

FIG. 7 is a flow diagram illustrating a periodical method in accordance with one or more embodiments.

A timer (e.g., a periodicGlobalModel-Timer) for a UE is introduced to let each UE to join for global AI/ML model training as periodical method.

As an example, a UE can start periodicGlobalModel-Timer after the reception of AI/ML model configuration information the initial selection of UE subset

When the periodicGlobalModel-Timer expires, the UE joins the candidate UE subset to operate local AI/ML model training. The UE restarts periodicGlobalModel-Timer after joining each global model training.

The periodicGlobalModel-Timer is configured by gNB through e,g., RRC reconfiguration message or system information.

The maximum value of periodicGlobalModel-Timer can be set to “infinity” which means periodical method can be disabled.

Referring to the FIG. 7, a timer of global AI/ML model training participation for each UE is reset at 701.

A timer check is performed at 702.

A global AI/ML model update is received at 704 after the timer of 702 expires. Otherwise, wait for the timer to expire at 703.

A local AI/ML model training is updated at 705.

Feedback for the local AI/ML model is generated/updated at 706.

A global AI/ML model is updated at 707.

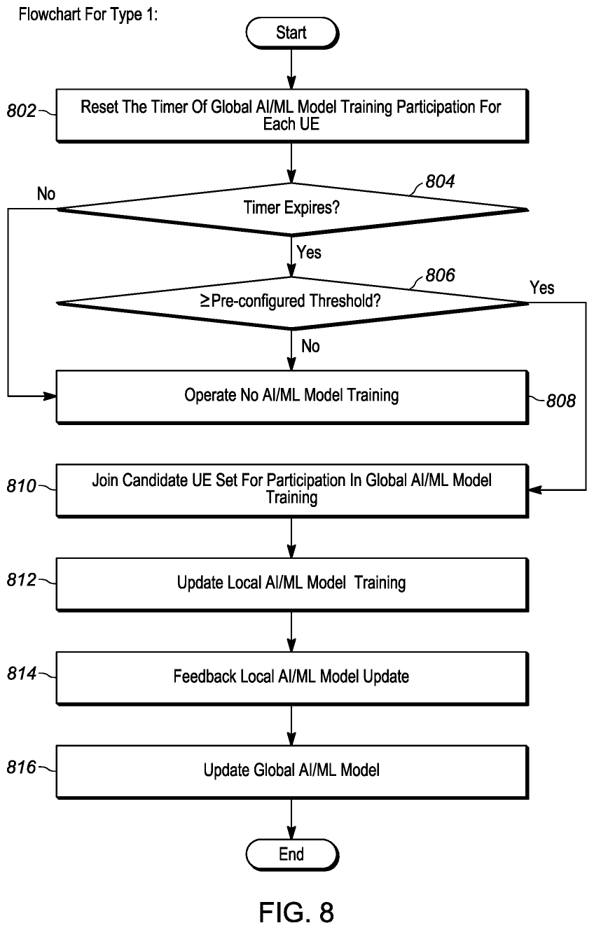

FIG. 8 is a flow diagram illustrating a hybrid method using trigger and periodical techniques in accordance with one or more embodiments.

Based on the event-triggering and periodical methods, the combination method of using both can be also used to enable UE subset for global AI/ML model training.

For execution of this combination method (Type 1), UE devices to join global model training if ≥Lₜₕ (pre-configured threshold) and timer expires. UE devices NOT to join global model training if <Lₜₕ (pre-configured threshold) and timer expires.

A Pre-configured threshold (Lₜₕ) can be set based on the configured threshold profile index.

A timer of global AI/ML model training participation for each UE is reset at 802.

A timer check is performed at 804.

If the timer expires, a threshold check is performed at 806. Otherwise, no AI/ML model training at 808.

If the threshold check is no, also no AI/ML model training at 808.

If the threshold check is yes, a candidate UE set for participation in global AI/ML model training is joined at 810.

Local AI/ML model training is updated at 812.

A local AI/ML model update is provided as feedback at 814.

A global AI/ML model is updated at 816.

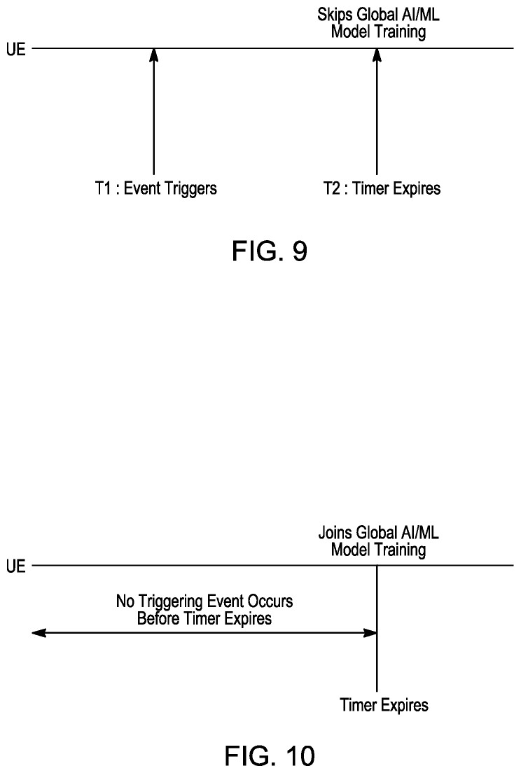

FIGS. 9 and 10 illustrate examples of event and periodic training in accordance with one or more aspects/embodiments.

In FIG. 9, there is an event trigger and a UE skips global AI/ML model training periodically. Here, the event triggers before timer expires (Type 2).

In FIG. 10, the UE joins global AI/ML model training periodically, if no triggering event occurs before timer expires (Type 3).

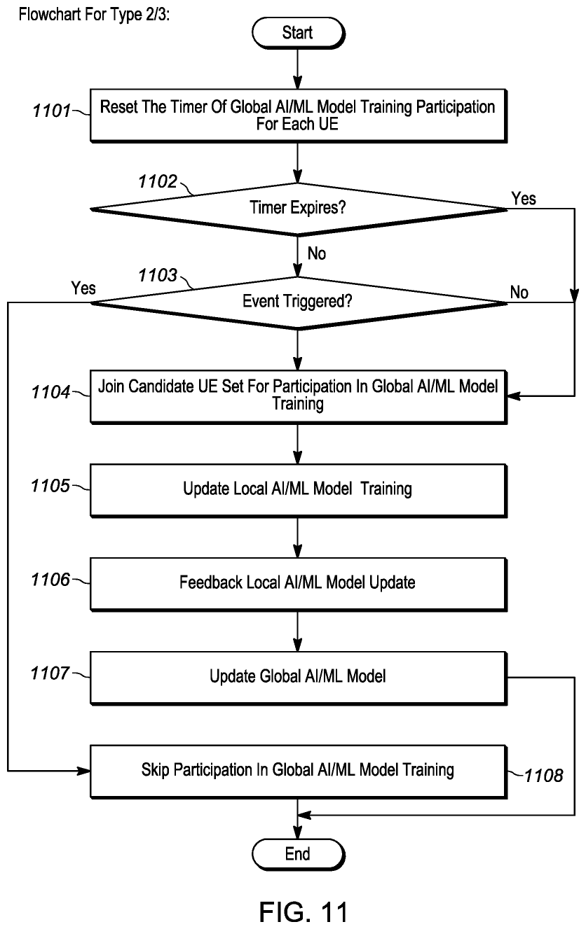

FIG. 11 is a flow diagram illustrating a hybrid method using trigger and periodical techniques in accordance with one or more embodiments.

A timer for a global AI/ML model training participation for each UE is reset at 1101.

A check of the timer is performed at 1102.

An event can be triggered at 1103.

If the timer expires and/or the event is not triggered, a candidate UE set for participation in global AI/ML model training is joined at 1104.

A local AI/ML model training is updated at 1105.

A local AI/ML model update is provided as feedback at 1106.

A global AI/ML model is updated at 1107.

If the event is triggered at 1103, participate in global AI/ML model training is skipped at 1108.

It is to be understood that the disclosure of multiple steps or functions disclosed in the specification or claims may not be construed as to be within the specific order. Therefore, the disclosure of multiple steps or functions will not limit these to a particular order unless such steps or functions are not interchangeable for technical reasons. Furthermore, in some embodiments a single step may include or may be broken into multiple sub steps. Such sub steps may be included and part of the disclosure of this single step unless explicitly excluded.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus, system, and the like to perform the actions.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in a memory, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory.

It is to be understood that aspects described herein can be implemented by hardware, software, firmware, or any combination thereof. When implemented in software, functions can be stored on or transmitted over as one or more instructions or code on a computer-readable medium. Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the s and/or actions described herein.

For a software implementation, techniques described herein can be implemented with modules (e.g., procedures, functions, and so on) that perform functions described herein. Software codes can be stored in memory units and executed by processors. Memory unit can be implemented within processor or external to processor, in which case memory unit can be communicatively coupled to processor through various means as is known in the art. Further, at least one processor can include one or more modules operable to perform functions described herein.

Techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), CDMA1800, etc. UTRA includes Wideband-CDMA (W-CDMA) and other variants of CDMA. Further, CDMA1800 covers IS-1800, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.18, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA1800 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1. A system having a base station (BS) and/or a user equipment (UE), comprising circuitry having:
a radio frequency (RF) interface; and
one or more processors configured to:
perform federated learning for artificial intelligence/machine learning (AI/ML).

2. The system of claim 1, the one or more processors configured to use an event triggering method.

3. The system of claim 1, the one or more processors configured to use a periodical method.

4. The system of claim 1, the one or more processors configured to use a hybrid method incorporating event triggering and periodical.

5. A system having a base station (BS) and/or a user equipment (UE), comprising circuitry having:
a radio frequency (RF) interface; and
one or more processors configured to:
set a timer for global artificial intelligence/machine learning (AI/ML) model training;
join a candidate UE set for participation in the global AI/ML model training based on an event trigger or the timer;
update local AI/ML model training;
feedback local AI/ML model update; and
update the global AI/ML model based on the feedback.
